(19) United States
(12) Patent Application Publication
(10) Pub. No.: US 2025/0232681 A1
(43) Pub. Date: Jul. 17, 2025

(54) OPTIMIZED FLIGHT MONITORING AND TURNAROUND HANDLING

(71) Applicant: THE BOEING COMPANY, Arlington, VA (US)

(72) Inventors: Alejandro GÜEMES JIMÉNEZ, Getafe (ES); Pablo COSTAS, Madrid (ES); Javier LOPEZ LEONES, Majadahonda (ES); Nicolas PEÑA ORTIZ, Madrid (ES); Andrés MUÑOZ HERNÁNDEZ, Madrid (ES); Elisa MORALES TIRADO, Madrid (ES)

(21) Appl. No.: 18/412,345

(22) Filed: Jan. 12, 2024

(51) Int. Cl. G08G 5/00

(52) U.S. Cl. CPC G08G 5/34; G08G 5/20; G08G 5/727

(57) ABSTRACT

The present disclosure provides techniques for optimized flight monitoring. A first set of traffic data for a flight is accessed. The first set of traffic data is saved in a data store. A user interface is updated to display the first set of traffic data for the flight. A second set of traffic data for the flight is received, where the second set of traffic data is received at a later time than the first set of traffic data. A progress of the flight is monitored by comparing the first and second sets of traffic data. Upon detecting a delay in the progress of the flight, the flight is highlighted on the user interface.

### FIELD

Aspects of the present disclosure relate to data processing and analysis, and, more specifically, to an advanced system that integrates continuous flight tracking with dynamic turnaround time monitoring to optimize aircraft scheduling and ground operations.

### BACKGROUND

Flight tracking is a complex process that includes multiple steps. It typically begins with data collection via Collaboration Human Machine Interface (CHMI) inputs and manual updates from ground handling agents, followed by data transmission of the collected information to a flight monitoring system for processing and analysis. However, ground handling agents may be delayed in message inputs, which can disrupt accurate scheduling and planning at the arrival airport. Additionally, manually tracking flight progress through CHMI can be inefficient and challenging for personnel, especially under abnormal circumstances like adverse weather or air traffic control disruptions. These inefficiencies or delays in message inputs in monitoring can impact the precision of flight scheduling and operations. Flight delays are not the only issue. Early arrivals can also create logistical challenges for ground agents. The unpredictability of these flight arrivals adds another layer of complexity to the management of flight operations. Furthermore, it has been shown that the simultaneous use of CHMI and Operations Control Center (OCC) systems for flight monitoring is not viable for human operators. This approach often leads to an unmanageable workload, which can significantly reduce the efficiency of the personnel involved. All of these factors, such as inefficiencies or delays in message inputs, the unpredictability of flight arrivals, and the unworkable load from concurrent use of CHMI and OCC systems, lead to the necessity of developing a streamlined flight tracking and monitoring system to improve the efficiency of managing flight operations.

### SUMMARY

The present disclosure provides a method in one aspect, the method including, accessing a first set of traffic data for a flight, saving the first set of traffic data in a data store, updating a user interface to display the first set of traffic data for the flight, receiving a second set of traffic data for the flight, where the second set of traffic data is received at a later time than the first set of traffic data, monitoring a progress of the flight by comparing the first and second sets of traffic data, and upon detecting a delay in the progress of the flight, highlighting the flight on the user interface.

Other aspects of this disclosure provide one or more non-transitory computer-readable media containing, in any combination, computer program code that, when executed by the operation of a computer system, performs operations in accordance with one or more of the above methods, as well as systems comprising one or more computer processors and one or more memories containing one or more programs, which, when executed by the one or more computer processors, perform operations in accordance with one or more of the above methods.

### BRIEF DESCRIPTION OF THE DRAWINGS

So that the manner in which the above recited features can be understood in detail, a more particular description, briefly summarized above, may be given by reference to example aspects, some of which are illustrated in the appended drawings.

FIG. 1 depicts an example flight tracking system, according to some aspects of the present disclosure.

FIG. 2A is a time diagram depicting the data reception of a flight tracking system, according to some aspects of the present disclosure.

FIG. 2B depicts an example frontend interface showing flight traffic data with highlights for flights that are either delayed or arriving early, according to some aspects of the present disclosure.

FIG. 3 depicts an example method of tracking flight status based on received flight data, according to some aspects of the present disclosure.

FIG. 4 depicts an example method of calculating turnaround time based on received flight data, according to some aspects of the present disclosure.

FIG. 5 depicts an example frontend interface showing traffic data for a landed flight and its linking flight with highlights for tight turnaround schedules, according to some aspects of the present disclosure.

FIG. 6 is a flow diagram depicting an example method for flight monitoring, according to some aspects of the present disclosure.

FIG. 7 depicts an example computing device for flight monitoring and turnaround time handling, according to some aspects of the present disclosure.

### DETAILED DESCRIPTION

The present disclosure provides an advanced system for continuously tracking the progress of flights and dynamically monitoring turnaround times for upcoming flights, leveraging flight data received from a third-party service provider.

In some aspects of the present disclosure, the system may comprise three components: a database, a backend, and a frontend. The database may serve as the central repository for storing the incoming flight data provided by one or more third-party service providers. The backend may self-manage subscriptions to one or more published queues provided by the one or more service providers (e.g., using the Advanced Message Queuing Protocol (AMQP)). In some aspects, the subscription may allow the backend to receive traffic data for air flights in real time (or near real time). In some aspects, the traffic data may include, but are not limited to, flight identifier (ID), call sign, aircraft registration number, departure and arrival airports, date, and a variety of timestamps for detailed flight tracking. The frontend may be configured to provide end users with a web-based, real-time visual representation of flight tracking status and/or other relevant data, such as, where applicable, flight turnaround times.

In some aspects of the present disclosure, the traffic data for each flight may be continuously updated within the system across the entire duration of a flight. The continuous updating may enable the system to track the progress of the flight in real time. Upon receiving the data, the backend of the system may parse through the data to ensure that the received data is promptly updated in the database and/or accurately reflected on the frontend interface.

In some aspects of the present disclosure, such as when changes in flight status (like delays) are identified, the affected flights may be highlighted on the frontend interface for quick identification by end users. In some aspects, the changes in a flight's progress may be determined by comparing two sets of traffic data received consecutively (e.g., comparing the currently received traffic data with the data received immediately before). For example, if the estimated time of arrival (ETA) in the current set of traffic data is later than the ETA in the preceding set, the system may identify this as a potential delay. Following the identification, the system may highlight (e.g., in red or other color) the affected flight on the frontend interface for immediate visibility. In some aspects, such as when the actual time of arrival (ATA) data for a flight is received (typically after landing), the system may compare the ATA in the current set of traffic data with the ETA from the preceding set. If the ATA is later than the previously estimated ETA, this indicates a flight delay. The system, in such configurations, may direct the frontend interface to highlight (e.g., in red or other color) the flight to emphasize the delay.

In some aspects of the present disclosure, the system may identify whether an aircraft (identified, e.g., by its tail number) is scheduled for a subsequent flight (also referred to in some aspects as a linking flight or a next flight). Upon such identification, the system may proceed to link the traffic data of the current flight with that of the next scheduled flight for the same aircraft. After the flight data are linked, the system may calculate the turnaround time for the aircraft concerning the next flight. In some aspects, the turnaround time may be defined as the interval between the ATA of the aircraft for its current flight and the estimated off-block time (EOBT) of its next scheduled flight. If the calculated turnaround time is found to fall below a defined threshold (indicating a shorter time than preferred for standard turnaround procedures), the system may direct the frontend interface to highlight (e.g., in red or other color) the affected flight, and/or transmit alerts to airline staff or personnel to take relevant proactive actions, such as delaying the linking flight, swapping the aircraft with another that is available or ready, and the like. In some aspects, the standard turnaround procedures may refer to the set of routine operations and tasks performed on an aircraft between its arrival and subsequent departure. These procedures may include, but are not limited to, boarding/off-boarding passengers, loading/unloading baggage, refueling, cleaning, loading meals for the next flight, performing necessary safety checks and maintenance. Each of these tasks may take a certain amount of time to complete. The preferred time for standard turnaround procedure may refer to the time frame that has been established (e.g., based on aircraft type, airline policies, or airport capabilities) to complete all these tasks without compromising safety, efficiency, or passenger comfort.

In some aspects of the present disclosure, the system may subscribe to one or more service providers, and integrate the traffic data provided by different providers for more effective and accurate flight tracking and turnaround time monitoring. For example, in some aspects, the system may subscribe to services that provide data on flight taxi times. As used herein, taxi time may refer to the period of time an aircraft spends taxiing on the runway, such as the time from landing to reaching the gate (in-block time), or the time from leaving the gate (off-block) to takeoff. The integration of taxi time data may allow the system to further refine its calculation of turnaround time (by deducting the taxi time). For example, the turnaround time may be determined by subtracting both the ATA of the current flight and the taxi time of the current flight after it landed (e.g., the time from landing to reaching the gate), from the EOBT of the next flight. The refined turnaround time is more accurate because the period between when the aircraft reaches the gate and departs is the actual window available for turnaround activities (e.g., maintenance checks, refueling, catering services).

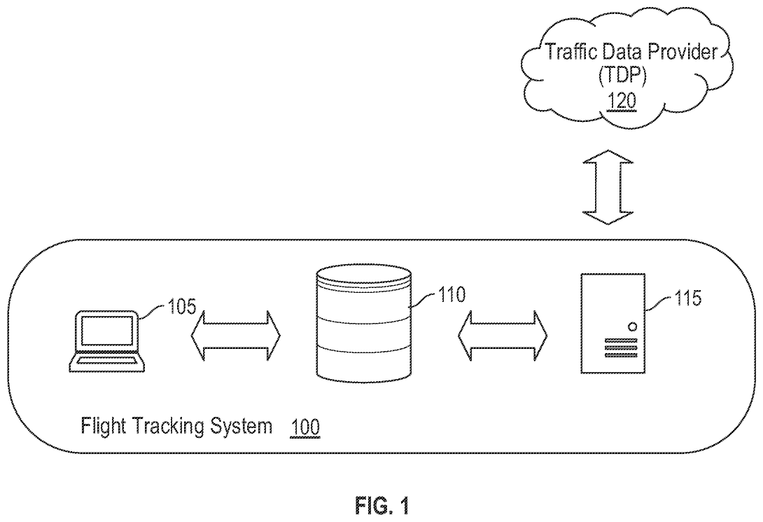

FIG. 1 depicts an example flight tracking system 100, according to some aspects of the present disclosure.

As illustrated, the flight tracking system 100 comprises three components, including a database 110, a backend server 115, and a frontend interface 105. The backend server 115 is configured to receive flight data from the traffic data provider (TDP) 120. Upon receiving the flight data, the backend server 115 parses the information provided and/or stores the data in the database 110. The backend server 115 also transmits the received flight traffic data to the frontend interface 105 for user interaction and visualization. In some aspects, the frontend interface 105 may provide a web-based, real-time visual representation of flight tracking status to end users. Several steps may be performed by the backend server 115 to receive or retrieve flight traffic data from the TDP 120. For example, the backend server may first establish a connection with the TDP 120 (or a message broker) using the Advanced Message Queuing Protocol (AMQP). The connection process may include authenticating the server's identity, and/or implementing security measures to establish a secure and reliable communication channel between the two entities. Upon successful connection, the backend server 115 then subscribes to a specific queue (e.g., flight_data) that contains the published flight traffic data from the TDP 120. Depending on the system's requirements, in some aspects, the subscription may be durable, which maintains across server restarts, whereas in other aspects, the subscription may be transient, where a new subscription is required when the server restarts. The backend server 115 may retrieve or receive flight traffic data continuously from the TDP 120 through the subscription. In some aspects, the backend server 115 may check the subscribed queue periodically (e.g., at defined time intervals) for new messages (or new traffic data). In some aspects, new messages (or new traffic data) may be pushed to the backend server 115 as they arrive in the queue in response to specific flight events, such as aircraft departing a gate (off-block), aircraft arriving a gate (in-block), aircraft takeoffs, and aircraft landings.

Once the flight traffic data is received, the backend server 115 processes the data to extract relevant parameters. In some aspects, the flight traffic data in each message may include parameters such as the flight identifier (ID), call sign, aircraft registration number, departure and arrival airports, date, estimated off-block time (EOBT), estimated take-off time (ETOT), estimated time of arrival (ETA), actual take-off time (ATOT), actual time of arrival (ATA), and other flight status data. In some aspects, the backend server 115 may save the updated traffic data in the database 110 for further analysis, and/or transmit the data to the frontend interface 105 for display to end users.

In some aspects, the backend server 115 may establish error handling mechanisms to manage errors or potential data losses. For example, the backend server 115 may set up a timer that is programmed to monitor the frequency of incoming messages. If the backend server 115 does not receive a message within a defined time frame (e.g., five minutes), the backend server 115 may trigger a procedure to check the status of the connection. In some aspects, the backend server 115, upon detecting a disconnection, may automatically attempt to reconnect to the TDP 120 (or the message broker).

In some aspects, the backend server 115 may receive new messages comprising updated traffic data from the published queue, either periodically or as triggered by specific events. Upon receiving these messages, the backend server 115 may compare the sets of traffic data received consecutively for any given flight to determine changes in the progress of flights. This comparison may enable the server 115 to identify delays, early arrivals, or on-time status.

In some aspects, such as when the ATA is not available in a received message (typically occurring when the aircraft is on the ground awaiting for takeoff or is flying and has not yet landed), the backend server 115 may compare the ETA in the current message with the ETA from the immediately preceding message. If the ETA in the current message is later than that in the preceding one, this suggests a potential flight delay. For example, a shift from a previous ETA of 12:30:00 to a current ETA of 12:35:00 may indicate a potential delay of the flight. Alternatively, if the ETA in the current message is earlier than that in the preceding one, this indicates that the flight is arriving earlier than anticipated, such as a change from a previous ETA of 12:40:00 to a current ETA of 12:35:00. Additionally, if the comparison reveals that the current ETA is equal to the previous ETA, an on-time status is detected, which suggests that the flight is following its scheduled arrival time.

In some aspects, such as when the ATA is available (indicating the aircraft has landed), the backend server 115 may determine the progress of a flight by comparing the received ATA with the ETA from the preceding message. If the current ATA (e.g., 14:20:00) is later than the previous ETA (e.g., 14:15:00), this suggests a flight delay. If the current ATA (e.g., 14:20:00) is earlier than the previous ETA (e.g., 14:25:00), this indicates an early arrival. Additionally, if the ATA matches the ETA exactly, this indicates that the flight is on schedule, with no status change.

Based on these analyses, in some aspects, the backend server 115 may transmit instructions to the frontend interface 105 to update its displayed flight information accordingly. This may include highlighting the delayed and/or early-arrived flights in different colors for clarity and quick identification by end users.

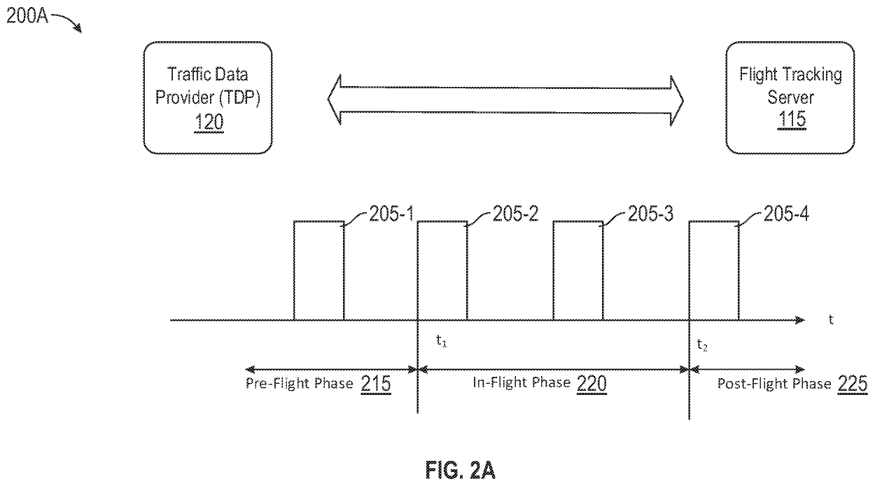

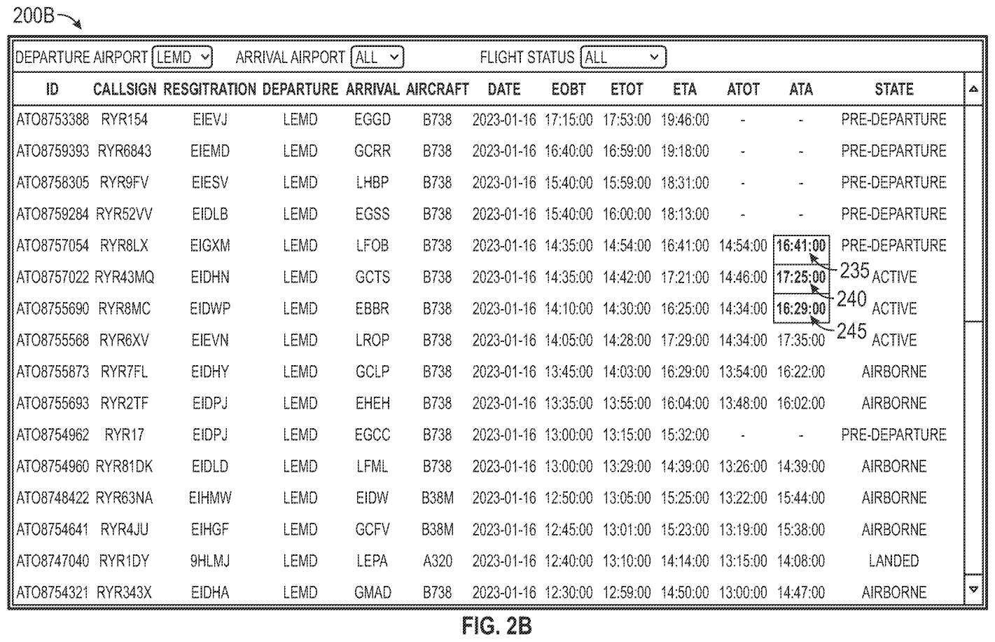

In some aspects, the frontend interface 105 may provide a visual representation of various flight data to end users. The visual representation may be web-based, application-based, or implemented through other means. In some aspects, the visual representation may include interactive components such as maps or graphs showing flight paths, and tables or charts listing detailed flight information (as depicted in FIG. 2B). In some aspects, the frontend interface 105 may offer functions or features that allow end users to search for specific flights using parameters like flight ID, call sign, aircraft registration number, departure and arrival airports, and date (or to sort flights by these parameters). Filters may be provided to assist end users to effectively narrow down the data based on such parameters. As discussed above, when changes (e.g., delays or early arrivals) are detected (e.g., by comparing flight data in current message with that in preceding message), the frontend interface 105 may highlight these changes and the affected flights for clarity and quick identification. Depending on the nature of these changes, different colors may be used for quick visual reference. For example, delayed flights may be highlighted in red, early-arrival flights may be marked in green, and unchanged flights (e.g., those that will arrive as expected) may remain in blue.

In some aspects, the backend server 115 may check the existing data in the database 110 to determine whether an aircraft (identified by its tail number), currently in the process of completing a flight, is scheduled for a subsequent flight (also referred to in some aspects as a next flight or a linking flight). Upon confirming that a subsequent flight is planned, the backend server 115 may aggregate the traffic data of the current flight with that of the next flight for the same aircraft, and/or calculate the turnaround time based on the aggregated data. In some aspects, the turnaround time for an aircraft's next flight may be determined by the interval between the ATA of the aircraft from its current flight and the EOBT of its next scheduled flight. For example, if an aircraft lands on the runway of an arrival airport at 14:50:00, this suggests that the ATA of its current flight is 14:50:00. After landing, the aircraft then moves to its designated gate. If the aircraft is scheduled to depart on its next flight and the time it is scheduled to leave the gate for the next flight is 15:30:00, this suggests that the EOBT of its next flight is 15:30:00. Based on the ATA and EOT, a resulting turnaround time is 40 minutes, which is the available time window for the aircraft to perform turnaround activities, such as cleaning, refueling, maintenance checking, passenger boarding/off-boarding, and luggage loading/unloading. After the turnaround time is determined, the backend server 115 may then compare it with a defined threshold. If the turnaround time falls below the threshold, it indicates that the next flight has a shorter turnaround time than usual or preferred, and may suggest the possibility of a delay. In such configurations, the backend server 115 may direct the frontend interface 105 to highlight the affected next flight, possible in red color, to alert end users (e.g., ground staff or airline personnel) of the potential tight turnaround time.

In some aspects, the backend server 115 may connect or subscribe to more than one TDP 120, each offering different types of data related to air flight. The connection or subscription may be established using AMQP or API calls. The backend server 115 may aggregate the data from various sources, and perform more effective and accurate flight tracking and turnaround time monitoring. For example, in some aspects, the backend server 115 may subscribe to services that provide real-time data on flight taxi time. As discussed above, taxi time may refer to the interval that begins from the time an aircraft lands on the runway (ATA) until it reaches the gate (in-block time). By incorporating taxi time into calculations, the backend server 115 may further refine the turnaround time estimation as follows: T=EOBTₙₑₓₜ−ATA_{current}−taxi_{current}, where T is the predicted turnaround time, EOBTₙₑₓₜ is the EOBT of the next flight for the same aircraft, −ATA_{current} is the ATA of the current flight, and taxi_{current} is the (estimated or predicted) taxi time of the current flight (e.g., the time until the flight reaches the gate or in-block time).

The inclusion of taxi time of the current flight in the calculation makes the estimated turnaround time more accurate because it considers the overlooked period the aircraft spends taxiing on the runway. This period may vary significantly depending on airport size, traffic congestion and other operational factors. By subtracting the taxi time from the calculation, the backend server 115 may estimate the turnaround time more accurately. The refined turnaround time better reflects the actual available time for each aircraft for turnaround activities. Relying on the refined turnaround time, end users (e.g., ground staff or traffic controllers) may take proactive measures to prevent potential delays. In some aspects, the proactive measures may include preparing for quicker boarding processes, making necessary adjustments to reduce baggage loading/unloading time, or assigning another aircraft that is available and ready to carry the next flight.

In some aspects, the backend server 115 may comprise physical servers, cloud servers, or a combination thereof. The backend server 115 may also integrate additional hardware components as needed, such as network interfaces, storage systems, and security applications, to enhance performance and data security.

In some aspects, the backend server 115, the database 110, and the frontend interface 105 may communicate with each other via a network. In some aspects, the backend server 115, the database 110, and the frontend interface 105 may be located remotely from each other, and the network may include or correspond to a wide area network (WAN), the Internet, an intranet, or any combination of suitable communication mediums that may be available, and may include wired, wireless, or a combination of wired and wireless links. In some aspects, the backend server 115, the database 110, and the frontend interface 105 may be local to each other (e.g., within the same local network and/or the same hardware system), and communicate with one another using any appropriate local communication medium, such as a local area network (LAN) (including a wireless local area network (WLAN)), hardwire, wireless link, or intranet, etc.

The network may be designed to provide connectivity not only for the depicted components but also for other systems, components, or resources within the flight tracking system 100. It may be implemented using protocols such as Transmission Control Protocol (TCP) and/or Internet Protocol (IP), to ensure reliable, secure, and standardized communication. In some aspects, the flight tracking system 100 may represent a cloud computing architecture, where the backend server 115, the database 110, and the frontend interface 105 may operate through a centralized cloud computing platform.

FIG. 2A is a time diagram 200A depicting the data reception of a flight tracking system, according to some aspects of the present disclosure.

In the illustrated time diagram 200A, the backend server 115 receives a sequence of messages 205 from a published queue provided by the TDP 120. Each message 205 contains flight traffic data that reflects the progress of flights at different times. The message 205 is transmitted across the entire duration of a flight, including pre-flight phase 215, in-flight phase 220, post-flight phase 225. During the pre-flight phase 215, messages may include information about the aircraft's preparation for departure, such as EOBT, ETOT, and ETA. The in-flight phase 220 includes the period from takeoff to landing. Messages received during this time period may include EOBT, ETOT, ETA, and ATOT (considering the aircraft has taken off). The post-flight phase 225 corresponds to the period after the aircraft has landed, and messages received during the post-flight phase may include EOBT, ETOT, ETA, ATOT and ATA (considering the aircraft has landed).

By processing the sequence of messages, the backend server 115 may effectively track the flight's status in real time. The reception of these messages may be either time-based, meaning occurring at predetermined time intervals (e.g., 10 minutes), or event-based, meaning triggered by specific flight events (e.g., takeoffs, landings).

In the illustrated time diagram 200A, the message 205-1 is received while the aircraft is still on the ground, prior to takeoff. As discussed above, the message may include data such as EOBT, ETOT, and ETA. The next message 205-2 is received at the time (t₁) of takeoff or shortly thereafter (e.g., a message is triggered by the takeoff), and the message 205-2 may include data such as EOBT, ETOT, ETA, and ATOT. The backend server 115, upon receiving the message 205-2, may proceed to compare the traffic data from message 205-2 with the traffic data from the preceding message, message 205-1. The comparison aims to identify any changes in the flight progress. For example, if the ETA listed in message 205-2 is later than the ETA in message 205-1 (e.g., changing from 12:30:00 to 12:45:00), it suggests that the flight's progress is potentially delayed. In such configurations, the backend server 115 may instruct the frontend server (e.g., 105 of FIG. 1) to mark the affected flight in red (as depicted by 240 in FIG. 2B). Alternatively, if the ETA in message 205-2 is earlier than the ETA in message 205-1 (e.g., changing from 12:30 to 12:25), it indicates that the flight's progress is potentially ahead of schedule, and the flight may arrive earlier than expected. In such configurations, the backend server 115 may direct the frontend server (e.g., 105 of FIG. 1) to mark the affected flight in green (as depicted by 245 in FIG. 2B). Additionally, when the ETA in message 205-2 is the same as the ETA in message 205-1, it indicates that the flight is on schedule, with no status change. Within the frontend interface, these on schedule flights may remain in blue (as depicted by 235 in FIG. 2B).

In the illustrated time diagram 200A, following the takeoff, message 205-3 is received during the in-flight phase 220. The message 205-3 may be triggered by a defined time interval or specific events, depending on the flight's progression. The message 205-3 may provide updates on flight's status, such as updated EOBT, ETOT, and ETA (ATOT remains unchanged). As discussed above, the backend server 115 may compare the traffic data from message 205-3 with the traffic data from the preceding message, message 205-2, to continuously track flight status and/or identify any changes during the in-flight phase 220. Message 205-4 is received at the time (t₂) of landing (or shortly thereafter). As discussed above, the message 205-4 may include ATA and other relevant data as the aircraft transitions to the on-ground phase. The backend server 115 may, again, check changes in flight status by comparing the ATA from message 205-4 with ETA from its preceding message 205-3. If the ATA is later than the ETA, such as if the ATA in message 205-4 is 12:40:00, while the ETA in message 205-3 is 12:35:00, it suggests the flight is delayed, and may be marked in red within the frontend interface. If the ATA is earlier than the ETA, such as if the ATA in message 205-4 is 12:40:00, while the ETA in message 205-3 is 12:45:00, it indicates the flight arrived earlier than anticipated, and may be marked in green within the frontend interface. Furthermore, If the ATA exactly matches the ETA (or is within a defined interval from the ETA), such as if both the ATA in message 205-4 and the ETA in message 205-3 are 12:35:00, it indicates that the flight is on schedule, and may be displayed in blue within the frontend interface.

The illustrated example depicts one message (205-1) received during the pre-flight phase 215, two messages (205-2 and 205-3) received during the in-flight phase 220, and one message (205-4) received during the post-flight phase 225 for conceptual clarity. In some aspects, any number of messages may be received during these three phases for effective tracking of flight status. The frequency and number of messages may vary depending on various factors, such as the length of a flight, airline protocols, air traffic control requirements, and/or the occurrence of events during a flight.

FIG. 2B depicts an example frontend interface 200B showing flight traffic data with highlights for flights that are either delayed or arriving early, according to some aspects of the present disclosure.

In the example frontend interface 200B, flight data received from a service provider (e.g., 120 of FIG. 2A) is displayed in a table format. The table includes 13 columns, each representing a specific parameter relevant to flight information. The columns include: flight ID, call sign, aircraft registration number, departure airport, arrival airport, date, EOBT, ETOT, ETA, ATOT, ATA, and flight state (e.g., pre-departure, active, airborne, landed). When changes in flight progress (e.g., delays or early arrivals) are detected (e.g., by comparing flight data in the current message with that in preceding message), the frontend interface 200B highlights these changes and/or the affected flights for quick identification. As illustrated, the delayed flight 240 is marked in red, the early-arrival flight 245 is marked in green, and the on-schedule flight 235 remains in blue.

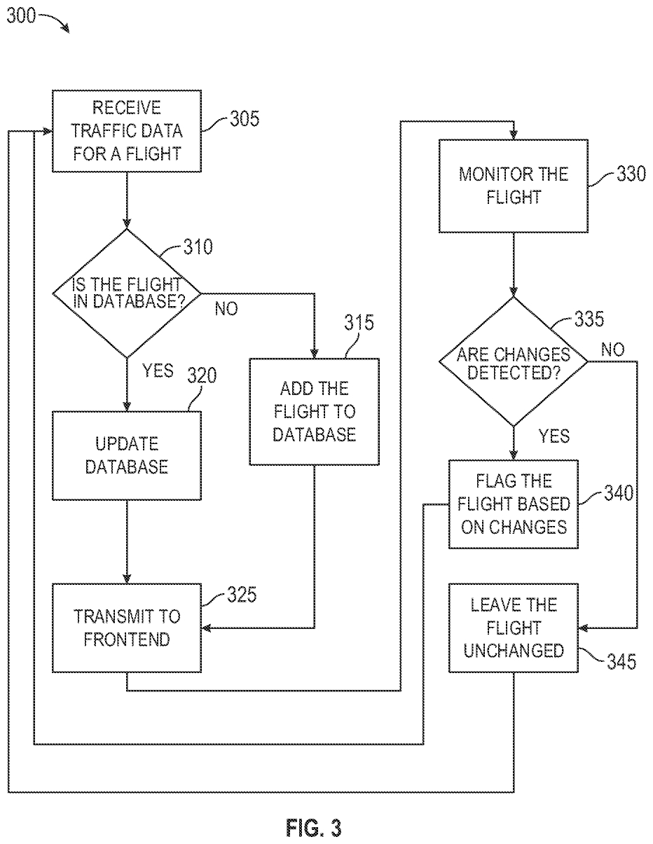

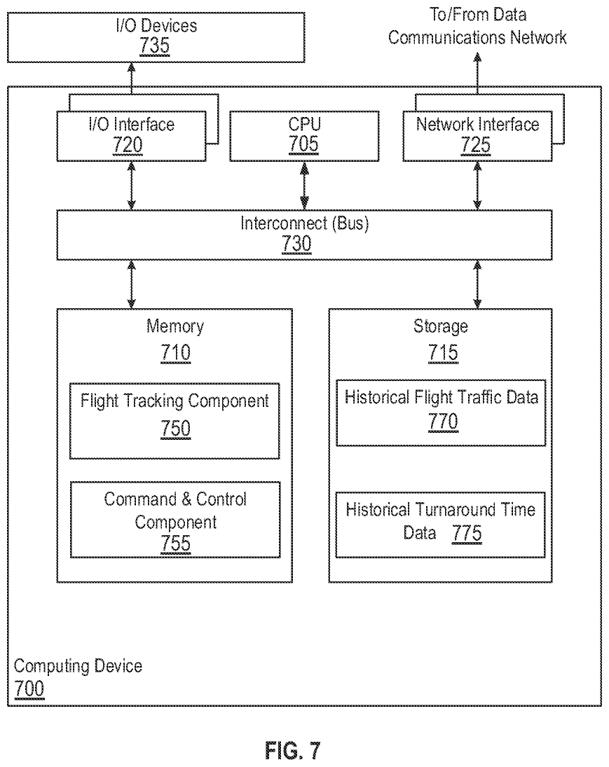

FIG. 3 depicts an example method 300 of tracking flight status based on received flight data, according to some aspects of the present disclosure. In some aspects, the method 300 may be performed by one or more computing systems or devices, such as the backend server 115 as depicted in FIGS. 1 and 2A, or the computing device 700 as depicted in FIG. 7.

The method 300 begins at block 305, where a computing system (e.g., the backend server 115 of FIG. 1) receives traffic data for a flight from a third-party service provider (e.g., TDP 120 of FIG. 1). In some aspects, the reception of the traffic data may be facilitated by subscribing to a published queue provided by the service provider using AMQP. The traffic data for the flight may include a wide range of parameters that identify and/or track the flight's progress, including but not limited to flight ID (which identifies the flight), call sign number (used for communication and control), aircraft registration number (which identifies the aircraft for the flight), the departure and arrival airports, and various timestamps for detailed flight tracking (e.g., EOBT, ETOT, ETA, ATOT, ATA, etc.).

At block 310, the computing system determines whether the database (e.g., 110 of FIG. 1) already contains existing traffic data for this flight. In some aspects, the check may be conducted using the flight ID (e.g., “AT08753388”) as a reference to search through the existing records in the database. If existing traffic data for the flight is found in the database (e.g., identified via the flight ID), the method 300 proceeds to block 320, where the computing system updates the existing records with the latest data received, to ensure the information in the database for this flight is current and accurate. If no existing records for this flight is found (indicating that this is a new entry), the method 300 moves to block 315, where the computing system creates a new record for the flight, and/or saves the received traffic data in the database.

At block 325, the computing system transmits or provides the updated (or newly received) data to the frontend interface (e.g., 105 of FIG. 1). The transmission ensures that the most recent status of the flight is properly displayed to end users.

At block 330, the computing system monitors the flight's progress or status by continuously receiving updated traffic data from the service provider (e.g., 120 of FIG. 1). The reception of these messages may be either time-based, whereby they occur at predetermined time intervals (e.g., 10 minutes), or event-based, whereby they are triggered by specific flight events (e.g., takeoffs, or landings). In such configurations, multiple sets of traffic data (e.g., 205 of FIG. 2A) may be received by the computing system across different flight phases. For example, during the pre-flight phase, the computing system may receive traffic data that reflects pre-departure changes. During the in-flight phase, the computing system may receive data that includes the aircraft's actual takeoff time and/or updates on estimated arrival times. During the post-flight phase, the computing system may receive data related to the aircraft's actual landing time.

At block 330, the computing system compares the multiple sets of traffic data to check for any status changes in the flight's progress (e.g., delays or early arrivals). For example, when the flight is on the ground awaiting takeoff or is flying and has not yet landed, the traffic data received may include the ETA of the flight. In such configurations, the computing system may analyze the data by comparing the ETA in the current set of traffic data with the ETA in the preceding set of data. If the current ETA is later than the previous one, the computing system may determine a potential delay of the flight. The method 300 proceeds to block 340, where the computing system guides the frontend interface to flag the flight in red color (as depicted by 240 of FIG. 2B). If the current ETA is earlier than the previous one, the computing system may identify a potential early arrival. The computing system then directs the frontend interface to highlight the flight in green color (as depicted by 245 of FIG. 2B). If the current ETA is equal to the previous one, the computing system may determine that no changes have been detected. The method 300 proceeds to block 345, where the computing system leaves the flight unchanged (e.g., remaining in blue) on the user interface.

In some aspects, such as when the flight has landed, the traffic data received may include the ATA of the flight. In such configurations, at block 335, the computing system may perform a comparison between the ATA in the current set of traffic data and the ETA in the preceding set of data. If the current ATA is later than the previous ETA, it indicates a delay of the flight. The method 300 proceeds to block 340, where the computing system guides the frontend interface to flag the flight in red color (as depicted by 240 of FIG. 2B). If the ATA is earlier than the previous ETA, it suggests an early arrival of the flight. The computing system then directs the frontend interface to highlight the flight in green color (as depicted by 245 of FIG. 2B). If the ATA matches the previous ETA exactly, no changes are detected. The method 300 proceeds to block 345, where the computing system leaves the flight unchanged (e.g., remaining in blue) on the user interface.

In some aspects, the comparison of traffic data between two consecutive sets of traffic data is a continuous process that spans the entire duration of a flight (including the pre-flight phase, the in-flight phase, and the post-flight phase). Once the computing system completes one comparison, it enters a waiting mode for the arrival of the next set of traffic data. As mentioned above, the reception of a new set of traffic data may be either time-based, meaning occurring at predefined intervals (e.g., 10 minutes), or event-based, meaning triggered by specific flight events (e.g., landings, takeoffs). In such configuration, there may be an interval or waiting period for the computing system until the next message (or new set of traffic data) is received. Upon receiving this new data, the computing system may promptly conduct another analysis to determine if there have been any changes since the most recent comparison. The cyclical process of receiving data, analyzing for changes, and waiting for the next update is maintained through the entire duration of the flight. When any changes are detected, such as delays, early arrivals, or other status updates, the system may guide the frontend interface to update accordingly. The cyclical process ensures that the information presented to end users (e.g., airline staff, traffic controllers, and passengers) is current and accurately reflects the real-time status of the flight.

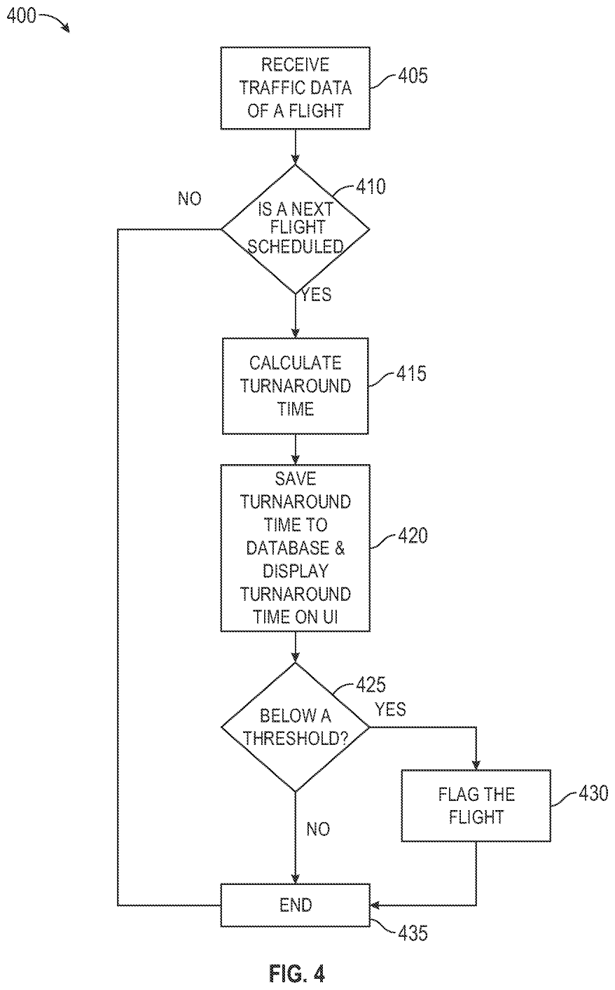

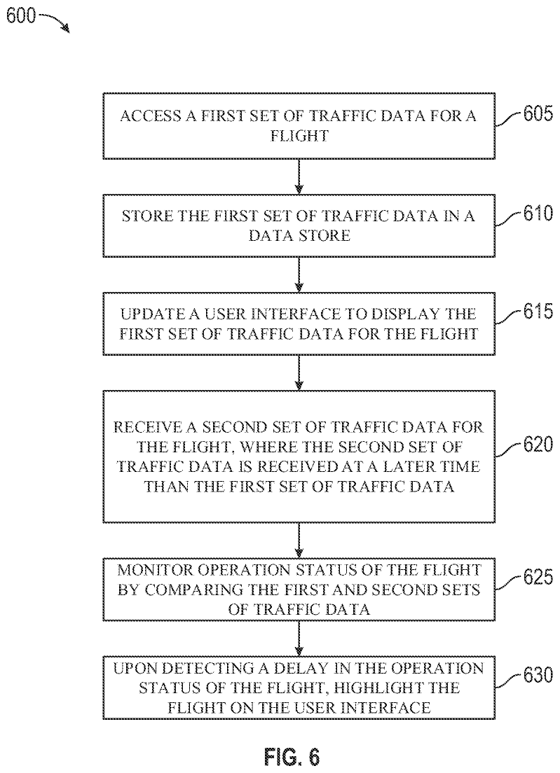

FIG. 4 depicts an example method 400 of calculating turnaround time based on received flight data, according to some aspects of the present disclosure. In some aspects, the method 400 may be performed by one or more computing devices, such as the backend server 115 as depicted in FIGS. 1 and 2A, or the computing device 700 as depicted in FIG. 6.

The method 400 begins at block 405, where a computing system (e.g., the backend server 115 of FIG. 1) receives traffic data for a flight from a third-party service provider (e.g., TDP 120 of FIG. 1). As discussed above, in some aspects, the reception of the traffic data may be facilitated by subscribing to a published queue provided by the service provider using AMQP. In some aspects, the traffic data may be transmitted through API calls. As discussed above, in some aspects, the traffic data for the flight may include flight ID (which identifies the flight), call sign number (used for communication and control), aircraft registration number (which identifies the aircraft for the flight), the departure and arrival airports, and various timestamps for detailed flight tracking (e.g., EOBT, ETOT, ETA, ATOT, ATA, etc.). In some aspects, the computing system may subscribe to a service provider (e.g., a Boeing Taxi Time API) that monitors flight taxi time in real-time, and the data received from the service provider may include flight taxi time. As mentioned above, taxi time may refer to the duration an aircraft spends taxiing on the runway and/or taxiway, either after landing or before takeoff. For example, after landing, the taxi time data provides information about the duration taken by the aircraft to move from the runway to its designated gate (in-block). Before takeoff, the taxi time reflects the time the aircraft spends moving from the gate or parking area (off-block) to the runway.

At block 410, the computing system checks the database (e.g., 110 of FIG. 1) to determine whether a subsequent flight (also referred to in some aspects as a next flight or a linking flight) has been scheduled for the aircraft operating the current flight. In some aspects, the verification process may be conducted using the aircraft tail number or aircraft registration number. These identifiers may be contained within the received traffic data. If the next flight is scheduled, the method 400 proceeds to block 415, where the computing system calculates the turnaround time for the next flight. If the next flight is not scheduled, the method 400 proceeds to block 435, where the turnaround evaluation process ends.

At block 415, the computing system calculates the turnaround time for the aircraft concerning the next flight. The estimated turnaround time may then be used for planning and managing the aircraft's ground activities between flights. In some aspects, the turnaround time may be determined by subtracting the ATA of the current flight from the EOBT of the next flight. For example, if the ATA of the aircraft for its current flight is recorded at 14:57:00, and the EOBT for its next scheduled flight is set at 15:31:00, the turnaround time for the aircraft is calculated as 36 minutes. The time interval defines the window available for all turnaround activities, such as refueling, aircraft cleaning, luggage loading/unloading, passenger off-boarding/onboarding, and the like. The accurate computation of the turnaround time may enable the computing system to coordinate with airline staff, to ensure that the turnaround activities are completed within the allocated time frame.

In some aspects, such as when the taxi time data is received for the current flight after it has landed or for the next flight before it takes off, the taxi time data may be used to further refine the turnaround time calculation. Under this approach, the turnaround time may be determined by subtracting both the ATA of the current flight (which indicates the time when the aircraft landed on the runway) and the taxi time of the current flight after it landed, from the EOBT of the next flight (which indicates the time when the aircraft leaves the gate). For example, if the ATA of the aircraft for its current flight is recorded at 14:57:00, the EOBT for its next scheduled flight is set at 15:31:00, and the taxi time for the current flight (the time taken from landing to reaching the gate) is recorded as 10 minutes, the calculation of the turnaround time may be 26 minutes. The resulting turnaround time (the time between when the aircraft reaches the gate and departs), which is the actual time window available for turnaround activities.

At block 420, the computing system saves the calculated turnaround time to the database (e.g., 110 of FIG. 1), and transmits the data to the frontend interface (e.g., 105 of FIG. 1) for display.

At block 425, the computing system checks whether the calculated turnaround time falls below a defined threshold. In some aspects, the threshold may be defined based on various factors, including but not limited to aircraft type (e.g., because larger aircraft may need longer time for tasks like refueling and boarding), flight destination and duration (e.g., because international flights may require more time for preparations and cleaning), operational standards of different airlines, and regulatory requirements of different airports. Once the threshold is defined, the system may use it as baseline to evaluate the calculated turnaround time. If the turnaround time is below the threshold, it indicates that the turnaround time for the flight is too short, and may potentially cause a delay. The method 400 proceeds to block 430, where the computing system directs the frontend interface (e.g., 105 of FIG. 1) to flag the affected flight, possibly in red or other color. In some aspects, alerts may be transmitted to airline staff or personnel. The alert may inform airline staff of the relatively tight turnaround time, and suggest they take relevant proactive measures, such as delaying the next flight, or swapping the aircraft with another that is available or ready. If the turnaround time is above or equal to the threshold, it suggests a relaxed schedule, indicating there is sufficient time for completing all necessary turnaround activities. The method 400 proceeds to block 435, where the turnaround evaluation process ends.

In some aspects, in addition to identifying and evaluating turnaround time for the immediately subsequent flight of the aircraft, the computing system may similarly evaluate future turnaround times for additional subsequent flights. For example, if the current turnaround time may cause the next flight to be delayed, the computing system may use this information to predict whether the subsequent flight (after the next flight) may be delayed (e.g., if the delay of the next flight may reduce the turnaround time of the subsequent flight).

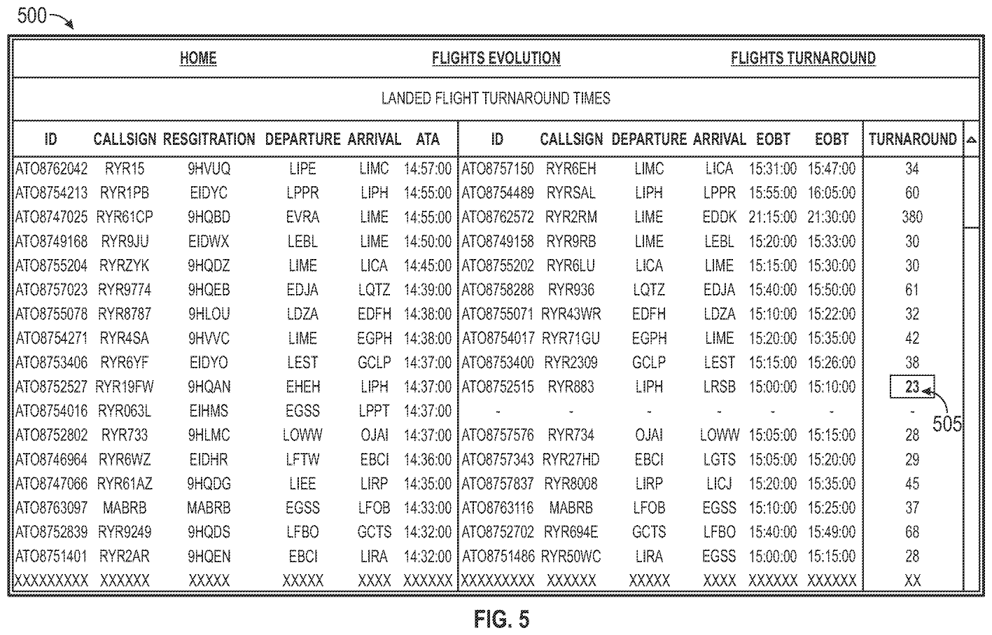

FIG. 5 depicts an example frontend interface 500 showing traffic data for a landed flight and a corresponding linking flight with highlights for short turnaround schedules, according to some aspects of the present disclosure.

In the example frontend interface 500, traffic data (received from a service provider) for a landed flight and its linking flight are displayed in a table format. As discussed above, the linking flight refers to a next scheduled flight that utilizes the same aircraft following the landed flight. The table includes 13 columns, with 6 related to the landed flight, 6 related to the linking flight, and one specifically for the calculated turnaround time. The 6 columns associated with the landed flight include: flight ID, call sign, aircraft registration number, departure airport, arrival airport, and ATA. The 6 columns associated with the linking flight include the flight ID, call sign, departure airport, arrival airport, EOBT and ETOT. When a calculated turnaround time falls below a defined threshold, as discussed in more detail in FIG. 4, the frontend interface 500 highlights the tight turnaround times and/or the affected flights for quick identification. As illustrated, the linking flight with a short turnaround 505 is marked in red. The illustrated table displaying traffic data for flights within 13 columns is provided for clarity and example purposes. Depending on specific requirements or preferences of the system, the flight traffic data may be displayed in a variety of formats, such as tables, bar charts, line charts, graphs, or other visual representations, each with any number of columns or data points.

FIG. 6 is a flow diagram depicting an example method 600 for flight monitoring, according to some aspects of the present disclosure.

At block 605, a computing system (e.g., the backend server 115 of FIGS. 1 and 2A) accesses a first set of traffic data (e.g., 205-1 of FIG. 2A) for a flight.

At block 610, the computing system stores the first set of traffic data in a data store (e.g., the database 110 of FIG. 1).

At block 615, the computing system updates a user interface (e.g., the frontend interface 105 of FIG. 1) to display the first set of traffic data for the flight.

At block 620, the computing system receives a second set of traffic data (e.g., 205-2 of FIG. 2A) for the flight, where the second set of traffic data is received at a later time than the first set of traffic data.

At block 625, the computing system monitors a progress of the flight by comparing the first and second sets of traffic data.

At block 630, upon detecting a delay in the progress of the flight, the computing system highlights the flight on the user interface (as depicted by 240 and 245 of FIG. 2B).

In some aspects, the first set of traffic data may be received at a first time when an aircraft associated with the flight has not landed, and the first set of traffic data may comprise a first estimated time of arrival (ETA) of the flight. In some aspects, the second set of traffic data may be received at a second time when the aircraft associated with the flight has not landed, and the second set of traffic data may comprise a second estimated time of arrival (ETA) of the flight. In some aspects, the computing system may detect the delay in the progress of the flight by determining that the second ETA is later than the first ETA.

In some aspects, the first set of traffic data may be received at a first time when an aircraft associated with the flight has not landed, and the first set of traffic data may comprise a first estimated time of arrival (ETA) of the flight. In some aspects, the second set of traffic data may be received at a second time when the aircraft associated with the flight has landed, and the second set of traffic data may comprise an actual time of arrival (ATA). In some aspects, the computing system may detect the delay in the progress of the flight by determining that the ATA is later than the first ETA.

In some aspects, the first and second sets of traffic data for the flight comprise at least one of: a flight identification number for the flight, a callsign for the flight, a registration number for an aircraft associated with the flight, an arrival airport of the flight, a departure airport of the flight, a date of the flight, an estimated off-block time (EOBT), an estimated take-off time (ETOT), an estimated time of arrival (ETA), an actual take-off time (ATOT), an actual time of arrival (ATA) or flight state information.

In some aspects, the computing system may further update the user interface to display the second set of traffic data for the flight, and update the data store to store the second set of traffic data for the flight.

In some aspects, the computing system may further identify a linking flight associated with the flight, receive traffic data for the linking flight, and calculate a turnaround time for the linking flight based on a comparison between the traffic data for the linking flight and the second set of traffic data for the flight.

In some aspects, the linking flight may be scheduled to depart subsequent to the arrival of the flight and may be operationally linked to the flight for aircraft allocation. In some aspects, the second set of traffic data for the flight may be received at a second time when an aircraft associated with the flight has landed, and the second set of traffic data for the flight may comprise an actual time of arrival (ATA) of the flight. In some aspects, the traffic data for the linking flight may comprise an estimated off-block time (EOBT) of the linking flight. In some aspects, the turnaround time for the linking flight may be determined based on a difference between the EOBT of the linking flight and the ATA of the flight.

In some aspects, the computing system may further update the user interface to display the turnaround time for the linking flight, and update the data store to store the turnaround time for the linking flight.

In some aspects, the computing system may further highlight the linking flight on the user interface when the turnaround time for the linking flight falls below a defined threshold.

In some aspects, the computing system may further receive additional traffic data for the flight, and update the turnaround time for the linking flight using the additional traffic data for the flight.

In some aspects, the additional traffic data for the flight may comprise a travel time between a time when an aircraft associated with the flight landed at an arrival airport and a time when the aircraft arrived at a gate.

In some aspects, the second set of traffic data for the flight may be received at a second time when an aircraft associated with the flight has landed, and the second set of traffic data for the flight may comprise an actual time of arrival (ATA) of the flight. In some aspects, the traffic data for the linking flight may comprise an estimated off-block time (EOBT) of the linking flight, and the turnaround time for the linking flight may be determined based on a difference between the EOBT of the linking flight and a sum of the ATA and the travel time of the flight.

FIG. 7 depicts an example computing device 700 for flight monitoring and turnaround time handling, according to some aspects of the present disclosure. Although depicted as a physical device, in some aspects, the computing device 700 may be implemented using a virtual device(s), and/or across a number of devices (e.g., in a cloud environment). The computing device 700 may be any type of computing device, such as the backend server 115 as illustrated in FIGS. 1 and 2A.

As illustrated, the computing device 700 includes a CPU 705, memory 710, storage 715, one or more network interfaces 725, and one or more I/O interfaces 720. In the illustrated computing device, the CPU 705 retrieves and executes programming instructions stored in memory 710, as well as stores and retrieves application data residing in storage 715. The CPU 705 is generally representative of a single CPU and/or GPU, multiple CPUs and/or GPUs, a single CPU and/or GPU having multiple processing cores, and the like. The memory 710 is generally included to be representative of a random access memory. Storage 7155 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some aspects, I/O devices 735 (such as keyboards, monitors, etc.) are connected via the I/O interface(s) 720. Further, via the network interface 725, the computing device 700 can be communicatively coupled with one or more other devices and components (e.g., via a network, which may include the Internet, local network(s), and the like). As illustrated, the CPU 705, memory 710, storage 715, network interface(s) 725, and I/O interface(s) 720 are communicatively coupled by one or more buses 730.

In the illustrated computing device, the memory 710 includes a flight tracking component 750 and a command & control component 755. Although depicted as a discrete component for conceptual clarity, in some aspects, the operations of the depicted component (and others not illustrated) may be combined or distributed across any number of components. Further, although depicted as software residing in memory 710, in some aspects, the operations of the depicted components (and others not illustrated) may be implemented using hardware, software, or a combination of hardware and software.

In one aspect, the flight tracking component 750 is configured to receive traffic data from a service provider, and/or process the data to extract relevant information. This may involve parsing the received data to extract flight IDs, aircraft registration number, relevant timestamps, flight status, or other relevant parameters. Based on the extracted information, the flight tracking component may monitor the progress of a flight and/or identify any changes from the scheduled times. In some aspects, these changes may be detected by comparing two sets of traffic data received consecutively. The comparison may allow the component 750 to identify variations in flight status, such as delays or early arrivals, by observing differences in parameters like ETA and ATA.

In one aspect, the command & control component 755 is configured to communicate with various systems and interfaces. For example, the command & control component 755 may send updated traffic data to a frontend interface (e.g., 105 of FIG. 1) for display, and/or transmit the data to a database (e.g., 110 of FIG. 1) for storage. When changes like delays or early arrivals are identified by the flight tracking component 750, the command & control component 755 may communicate these changes to the frontend interface, guiding it to display these affected flights distinctively, such as marking delayed flights in red and early-arrived flights in green. The visual differentiation may aid end users in quickly identifying the status of each flight.

In the illustrated example, the storage 715 may include historical flight traffic data 770 and historical turnaround time data 775. These historical data may be stored and utilized for further analysis to identify flight patterns and trends over time. For example, by analyzing the historical turnaround time data 775, the computing device may determine the average turnaround duration for each flight. Additionally, through an examination of the historical flight traffic data 770, the computing device may identify patterns of frequently occurring delays, and/or learn variations in air traffic during different times of the year. In some aspects, as depicted in FIG. 1, the aforementioned data may be saved in a remote database 110 that connects to the computing device 700 (e.g., the backend server 115) via a network.

In some aspects, the disclosed computing system (e.g., the flight tracking system 100 of FIG. 1, the computing device 700 of FIG. 7), designed for flight monitoring and turnaround time handling, may be utilized in other settings where monitoring of arrival and departure time is required for maintaining efficient services. For example, in rail travel, the system may be used for tracking train schedules, to ensure timely departures and arrivals and efficiently manage platform assignments. The system may also be used in maritime operations, monitoring the movements of ships, ferries, or other marine-crafts. In public transportation systems, such as bus or metro services, the system may be used to track the arrival and departure times of each bus, to enhance the accuracy of bus scheduling and improve the overall passenger experience.

In the current disclosure, reference is made to various aspects. However, it should be understood that the present disclosure is not limited to specific described aspects. Instead, any combination of the following features and elements, whether related to different aspects or not, is contemplated to implement and practice the teachings provided herein. Additionally, when elements of the aspects are described in the form of “at least one of A and B,” it will be understood that aspects including element A exclusively, including element B exclusively, and including element A and B are each contemplated. Furthermore, although some aspects may achieve advantages over other possible solutions and/or over the prior art, whether or not a particular advantage is achieved by a given aspect is not limiting of the present disclosure. Thus, the aspects, features, aspects and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects described herein may be embodied as a system, method or computer program product. Accordingly, aspects may take the form of an entirely hardware aspect, an entirely software aspect (including firmware, resident software, micro-code, etc.) or an aspect combining software and hardware aspects that may all generally be referred to herein as a “circuit,” “module” or “system.” Furthermore, aspects described herein may take the form of a computer program product embodied in one or more computer readable storage medium(s) having computer readable program code embodied thereon.

Program code embodied on a computer readable storage medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to aspects of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various aspects of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While the foregoing is directed to aspects of the present disclosure, other and further aspects of the disclosure may be devised without departing from the basic scope thereof, and the scope thereof is determined by the claims that follow.

What is claimed is:

1. A method comprising:
accessing a first set of traffic data for a flight;
storing the first set of traffic data in a data store;
updating a user interface to display the first set of traffic data for the flight;
receiving a second set of traffic data for the flight, wherein the second set of traffic data is received at a later time than the first set of traffic data;
monitoring a progress of the flight by comparing the first and second sets of traffic data; and
upon detecting a delay in the progress of the flight, highlighting the flight on the user interface.

2. The method of claim 1, wherein:
the first set of traffic data is received at a first time when an aircraft associated with the flight has not landed, and the first set of traffic data comprises a first estimated time of arrival (ETA) of the flight;
the second set of traffic data is received at a second time when the aircraft associated with the flight has not landed, and the second set of traffic data comprises a second estimated time of arrival (ETA) of the flight; and
detecting the delay in the progress of the flight further comprises determining that the second ETA is later than the first ETA.

3. The method of claim 1, wherein:
the first set of traffic data is received at a first time when an aircraft associated with the flight has not landed, and the first set of traffic data comprises a first estimated time of arrival (ETA) of the flight;
the second set of traffic data is received at a second time when the aircraft associated with the flight has already landed, and the second set of traffic data comprises an actual time of arrival (ATA); and
detecting the delay in the progress of the flight further comprises determining that the ATA is later than the first ETA.

4. The method of claim 1, wherein each of the first and second sets of traffic data for the flight comprises at least one of:
(i) a flight identification number for the flight;
(ii) a call sign for the flight;
(iii) a registration number for an aircraft associated with the flight;
(iv) an arrival airport of the flight;
(v) a departure airport of the flight;
(vi) a date of the flight;
(vii) an estimated off-block time (EOBT);
(viii) an estimated take-off time (ETOT);
(vx) an estimated time of arrival (ETA);
(x) an actual take-off time (ATOT);
(xi) an actual time of arrival (ATA); or
(xii) flight state information.

5. The method of claim 1, further comprising:
updating the user interface to display the second set of traffic data for the flight; and
updating the data store to store the second set of traffic data for the flight.

6. The method of claim 1, further comprising:
identifying a linking flight associated with the flight;
receiving traffic data for the linking flight; and
calculating a turnaround time for the linking flight based on a comparison between the traffic data for the linking flight and the second set of traffic data for the flight.

7. The method of claim 6, wherein the linking flight is scheduled to depart subsequent to the arrival of the flight and is operationally linked to the flight for aircraft allocation.

8. The method of claim 6, wherein:
the second set of traffic data for the flight is received at a second time when an aircraft associated with the flight has already landed;
the second set of traffic data for the flight comprises an actual time of arrival (ATA) of the flight;
the traffic data for the linking flight comprises an estimated off-block time (EOBT) of the linking flight; and
the turnaround time for the linking flight is determined based on a difference between the EOBT of the linking flight and the ATA of the flight.

9. The method of claim 6, further comprising:
updating the user interface to display the turnaround time for the linking flight; and
updating the data store to store the turnaround time for the linking flight.

10. The method of claim 6, further comprising highlighting the linking flight on the user interface when the turnaround time for the linking flight falls below a defined threshold.

11. The method of claim 6, further comprising:
receiving additional traffic data for the flight; and
updating the turnaround time for the linking flight using the additional traffic data for the flight.

12. The method of claim 11, wherein the additional traffic data for the flight comprises a travel time between a time when an aircraft associated with the flight landed at an arrival airport and a time when the aircraft arrived at a gate.

13. The method of claim 12, wherein:
the second set of traffic data for the flight is received at a second time when an aircraft associated with the flight has already landed;
the second set of traffic data for the flight comprises an actual time of arrival (ATA) of the flight;
the traffic data for the linking flight comprises an estimated off-block time (EOBT) of the linking flight; and
the turnaround time for the linking flight is determined based on a difference between the EOBT of the linking flight and a sum of the ATA and the travel time of the flight.

14. A system comprising:
one or more computer processors; and
one or more memories collectively containing one or more programs, which, when executed by the one or more computer processors, perform operations, the operations comprising:
accessing a first set of traffic data for a flight;
storing the first set of traffic data into a data store;
updating a user interface to display the first set of traffic data for the flight;
receiving a second set of traffic data for the flight, wherein the second set of traffic data is received at a later time than the first set of traffic data;
monitoring a progress of the flight by comparing the first and second sets of traffic data; and
upon detecting a delay in the progress of the flight, highlighting the flight on the user interface.

15. The system of claim 14, wherein:
the first set of traffic data is received at a first time when an aircraft associated with the flight has not landed, and the first set of traffic data comprises a first estimated time of arrival (ETA) of the flight;
the second set of traffic data is received at a second time when the aircraft associated with the flight has not landed, and the second set of traffic data comprises a second estimated time of arrival (ETA) of the flight; and
detecting the delay in the progress of the flight further comprises determining that the second ETA is later than the first ETA.

16. The system of claim 14, wherein:
the first set of traffic data is received at a first time when an aircraft associated with the flight has not landed, and the first set of traffic data comprises a first estimated time of arrival (ETA) of the flight;
the second set of traffic data is received at a second time when the aircraft associated with the flight has already landed, and the second set of traffic data comprises an actual time of arrival (ATA); and
detecting the delay in the progress of the flight further comprises determining that the ATA is later than the first ETA.

17. The system of claim 14, wherein the one or more programs, which, when executed on any combination of the one or more computer processors, perform the operations further comprising:
identifying a linking flight associated with the flight;
receiving traffic data for the linking flight; and
calculating a turnaround time for the linking flight based on a comparison between the traffic data for the linking flight and the second set of traffic data for the flight.

18. The system of claim 17, wherein:
the second set of traffic data for the flight is received at a second time when an aircraft associated with the flight has already landed,
the second set of traffic data for the flight comprises an actual time of arrival (ATA) of the flight,
the traffic data for the linking flight comprises an estimated off-block time (EOBT) of the linking flight, and
the turnaround time for the linking flight is determined based on a difference between the EOBT of the linking flight and the ATA of the flight.

19. The system of claim 17, wherein the one or more programs, which, when executed on any combination of the one or more computer processors, perform the operations further comprising highlighting the linking flight on the user interface when the turnaround time for the linking flight falls below a defined threshold.

20. One or more non-transitory computer-readable media containing, in any combination, computer program code that, when executed by operation of a computer system, performs operations comprising:
accessing a first set of traffic data for a flight;
storing the first set of traffic data in a data store;
updating a user interface to display the first set of traffic data for the flight;
receiving a second set of traffic data for the flight, wherein the second set of traffic data is received at a later time than the first set of traffic data;
monitoring a progress of the flight by comparing the first and second sets of traffic data; and
upon detecting a delay in the progress of the flight, highlighting the flight on the user interface.
